(19) United States
(12) Patent Application Publication
(10) Pub. No.: US 2021/0029424 A1
(43) Pub. Date: Jan. 28, 2021

(54) PROTECTIVE OUTER CASE FOR AUDIO DEVICE SYSTEMS

(71) Applicant: Samsonite IP Holdings S.àr.l., Luxembourg (LU)

(72) Inventors: Monica Elizabeth Wright, Falls Church, VA (US); Darrick Del Moral, San Bruno, CA (US); Bryan Vo, San Francisco, CA (US); Christopher William Ledesma, Arcadia, CA (US); Bryan Lee Hynecek, Redwood City, CA (US)

(73) Assignee: Samsonite IP Holdings S.àr.l., Luxembourg (LU)

(21) Appl. No.: 16/522,408

(22) Filed: Jul. 25, 2019

(51) Int. Cl. H04R 1/02; H04R 1/10

(52) U.S. Cl. CPC H04R 1/02; H04R 1/1041; H04R 1/1025; H04R 1/1091

(57) ABSTRACT

An outer case for covering a handheld electronic device or handheld electronic device case includes a base, lid, and connecting portion. The base includes an elastomeric first layer and a second layer attached to the first layer and made of a different material than the first layer. The lid includes an elastomeric first layer and a second layer attached to the first layer and made of a different material than the first layer. The connecting portion is attached along a rear wall of the base and a rear wall of the lid. The rear walls of the base and the lid and the connecting portion are flush when the outer case is in a closed state with the lid covering an opening defined by the base. The connecting portion suspends the lid when the outer case is in a fully open state with the lid spaced from the base.

### FIELD OF THE INVENTION

The present application relates generally to audio accessories, and in particular, to a protective case for audio device systems.

### BACKGROUND OF THE INVENTION

Wireless earbuds, such as Airpods® by Apple, Inc., are used in conjunction with a charging case. These charging cases are rigid to prevent damage to the earbuds contained in them. Left exposed, the charging cases are susceptible to scratches and to damage from the environment.

Various coverings for the charging cases that house the earbuds have been developed to address these issues. Soft-touch silicone has been a preferred material to provide cushioning when the earbud case, a frictional surface for a better grip on the case, and significant scratch resistance.

Although these coverings offer significant benefits over the use of charging cases alone as an external covering for wireless earbuds, such coverings also have significant limitations. The use of silicone to provide an external surface for these coverings creates a highly frictional surface on the coverings that makes them difficult to place in and to remove from user's pockets and other tight places. External hinges of certain cases or recesses in bases for accommodating rotations of lids attached to the bases of certain cases snag on clothing or other objects in the external environment which subjects the earbud system and casings to potential drops or other shocks and possible loss.

Accordingly, coverings with lower friction and less susceptibility to snags are desirable.

### SUMMARY OF THE INVENTION

In accordance with an aspect of the invention, an outer case for covering a handheld electronic device or handheld electronic device case may include a base, a lid, and a connecting portion. The base may include a first base layer which may be made of an elastomeric first material and a second base layer which may be attached to the first base layer and which may be made of a second material different from the first material. The lid may include a first lid layer which may be made of an elastomeric third material and a second lid layer which may be attached to the first lid layer and which may be made of a fourth material different from the third material. The connecting portion may be attached along a rear wall of the base and a rear wall of the lid. The rear wall of the base, the rear wall of the lid, and the connecting portion may be flush when the outer case is in a closed state with the lid covering an opening defined by the base. The connecting portion may suspend the lid when the outer case is in a fully open state with the lid spaced from the base.

In some arrangements, the second and the fourth materials may be rigid materials.

In some arrangements, the first base layer and the first lid layer may define an interior of the outer case, and the second base layer and the second lid layer may define an exterior of the outer case.

In some arrangements, the first material and the third material may be the same material, and the second material and the fourth material may be the same material.

In some arrangements, the connecting portion may be a hinge such that the lid rotates relative to the base via the connecting portion in a direction away from the base towards the fully the open state of the outer case.

In some arrangements, the lid may include a lid flange, and the base may include a base flange closer to an opening defined by the base in an open state of the outer case than the lid flange when the outer case is in the closed state.

In some arrangements, the outer case may further include a hook or loop. The hook or loop may extend from the base. The hook or loop may be integral with the first base layer such that the hook or loop and the first base layer may be inseparable without fracture of either one or both of the hook or loop and the first base layer. The hook or loop may extend from the first base layer through the second base layer.

In some arrangements, the base, the lid, and the connecting portion may be integral such that the base, the lid, and the connecting portion may be inseparable without fracture of any one or any combination of the base, the lid, and the connection portion.

In some arrangements, either one or both of the base and the lid may be made of co-molded or co-casted polymer layers.

In some arrangements, either one or both of the base and the lid may be made of a plurality of layers attached by an adhesive.

In some arrangements, the first material and the third material each may include at least one material selected from the group consisting of thermoplastic elastomers (“TPEs”), thermoplastic polyurethane (“TPU”), silicone, rubber, and any combinations of these materials.

In some arrangements, the second material and the fourth material each may include at least one material selected from the group consisting of hardened plastic materials, rigid or semi-rigid plastic materials, rigid rubber materials, polycarbonate materials, metals, alloys, para-aramid materials, wood, glass, mirror, quartz, and any combinations of these materials.

In some arrangements, an outer surface or outer surfaces of any one or any combination of the first base layer, the second base layer, the first lid layer, and the second lid layer may include an antimicrobial substance or treatment. In such arrangements, the antimicrobial substance or treatment may be selected from the group consisting of silver and silver alloys, copper and copper alloys, organosilanes, quaternary ammonium compounds, chlorhexidine, chlorhexidine incorporated hydroxyapatite materials, chlorhexidine-containing polymers, and antibiotics.

In some arrangements, the outer case may conform to and may be configured for covering a case, which may be a charging case, for storing earbuds, which may be wireless earbuds.

In some arrangements, the outer case may be configured for covering one or more earbuds, a microphone or case therefor, a voice recorder or case therefor, a remote control device or case therefor, a pager or case therefor, or a video game controller or case therefor.

In some arrangements, the outer case may further include a cushion and a ridge. The cushion may be attached to the lid. The ridge may be attached to the lid on a side of the lid opposite the cushion. The cushion may be configured to compress the one of the handheld electronic device or the handheld electronic device case covered by the outer case.

In some such arrangements, the cushion may be attached to the first lid layer and the ridge may be attached to the second lid layer.

A handheld electronic device system may include either one or both of a handheld electronic device and a handheld electronic device case configured for holding the electronic device and an outer case enclosing the one or both of the electronic device and the electronic device case in a first state and exposing the one or both of the electronic device and the electronic device case in a second state. The outer case may include a base, a lid, and a connecting portion. The base may include a first base layer which may be made of an elastomeric first material and a second base layer which may be attached to the first base layer and which may be made of a second material different from the first material. The lid may include a first lid layer which may be made of an elastomeric third material and a second lid layer which may be attached to the first lid layer and which may be made of a fourth material different from the third material. The connecting portion may be attached along a rear wall of the base and a rear wall of the lid. The rear wall of the base, the rear wall of the lid, and the connecting portion may be flush when the outer case is in a closed state with the lid covering an opening defined by the base. The connecting portion may suspend the lid when the outer case is in a fully open state with the lid spaced from the base.

In some arrangements, the handheld electronic device system may include both the handheld electronic device and the handheld electronic device case. In such arrangements, the handheld electronic device may be held within the electronic device case.

In accordance with another aspect, an outer case for covering a handheld electronic device or handheld electronic device case may include a base, a lid, and a flexible hinge. The lid may be configured for placement onto the base. The lid may have a first state in which the lid is placed on the base and a second state in which the lid is spaced from the base. The flexible hinge may be attached to the base and the lid. The flexible hinge may be in the form of a curved sheet when the lid is in the first state and may be in the form of a paraboloid when the lid is in the second state.

### BRIEF DESCRIPTION OF THE DRAWINGS

A more complete appreciation of the subject matter of the present invention and various advantages thereof may be realized by reference to the following detailed

description and the accompanying drawings, in which:

FIG. 1 is a top perspective view of an audio device system (shown in broken lines) encapsulated by a protective outer case, shown in an open state in accordance with an embodiment;

FIG. 2 is a top perspective view of the outer case of FIG. 1, shown in the open state, in accordance with an embodiment;

FIG. 3 is a front view of the outer case of FIG. 2, shown in the open state;

FIG. 4 is a rear view of the outer case of FIG. 2, shown in the open state;

FIG. 5 is a right side view of the outer case of FIG. 2, shown in the open state;

FIG. 6 is a left side view of the outer case of FIG. 2, shown in the open state;

FIG. 7 is a top view of the outer case of FIG. 2, shown in the open state;

FIG. 8 is a bottom view of the outer case of FIG. 2, shown in the open state;

FIG. 9 is a bottom perspective view of the outer case of FIG. 2, shown in the open state;

FIG. 10 is a top perspective view of the outer case of FIG. 1, shown in the closed state in accordance with another embodiment;

FIG. 11 is a front view of the outer case of FIG. 10, shown in the closed state;

FIG. 12 is a rear view of the outer case of FIG. 10, shown in the closed state;

FIG. 13 is a right side view of the outer case of FIG. 10, shown in the closed state;

FIG. 14 is a left side view of the outer case of FIG. 10, shown in the closed state;

FIG. 15 is a top view of the outer case of FIG. 10, shown in the closed state;

FIG. 16 is a bottom view of the outer case of FIG. 10, shown in the closed state;

FIG. 17 is a bottom perspective view of the outer case of FIG. 10, shown in the closed state;

FIG. 18 is a top perspective view of a protective outer case, shown in an open state, in accordance with another embodiment;

FIG. 19 is a front view of the outer case of FIG. 18, shown in the open state;

FIG. 20 is a top perspective view of a protective outer case, shown in the open state, in accordance with another embodiment;

FIG. 21 is a cross-sectional right side view of a protective outer case, shown in a closed state, in accordance with another embodiment;

FIG. 22 is a cross-sectional right side view of an in-process protective outer case;

FIG. 23 is a bottom perspective view of an outer lid layer of the outer cases of FIGS. 1, 10, 18, and 20 in accordance with another embodiment;

FIG. 24 is a top perspective view of a protective outer case, shown in an open state, in accordance with another embodiment; and

FIG. 25 is a bottom perspective view of the outer case of FIG. 24, shown in the open state.

### DETAILED DESCRIPTION

It is to be understood that the figures and descriptions of the present invention have been simplified to illustrate elements that are relevant for a clear Understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

Any numerical ranges set forth herein are included to individually disclose every sub-range and number, both whole integer and partial fraction, within the disclosed range. For example, a disclosed range of 1-100 is intended to individually disclose 10-90, 40-70, 29.5-60.2, 65, 57.3, 94.512924, and every other range and number that falls within the recited range.

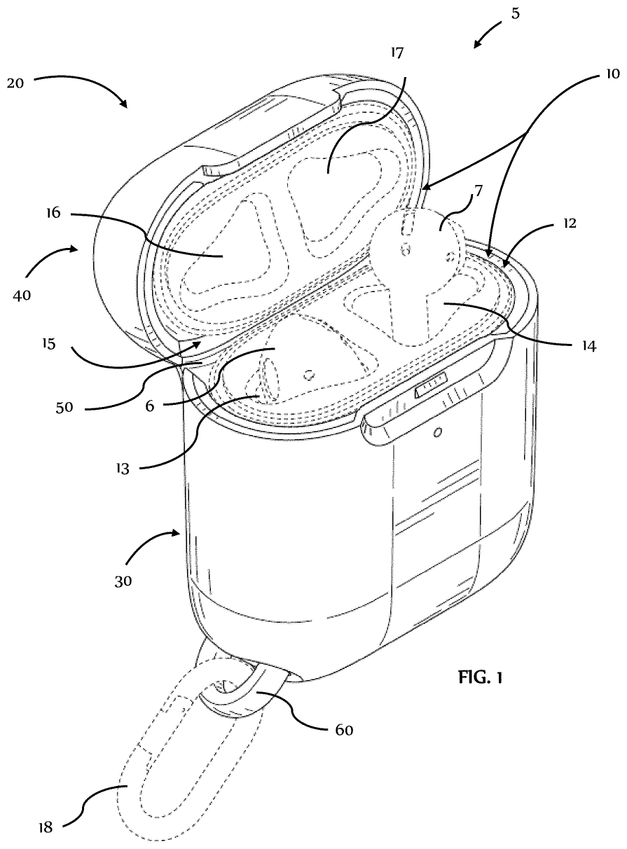

Referring now to FIG. 1, audio device system 5 includes left earbud 6, right earbud 7, charging case 10, carabiner 18, and outer case 20. Charging case 10 includes charging base 12 and charging lid 15 attached to the charging base. Charging base 12 includes left and right base cavities 13, 14 with shapes corresponding to the respective shapes of bottom portions of left and right earbuds 6, 7. Charging lid 15 includes left and right lid cavities 16, 17 with shapes corresponding to the respective shapes of top portions of left and right earbuds 6, 7 such that upon closure of the lid, the left earbud is enclosed by left base cavity 13 and the left lid cavity and the right earbud is enclosed by right base cavity 14 and right lid cavity 17.

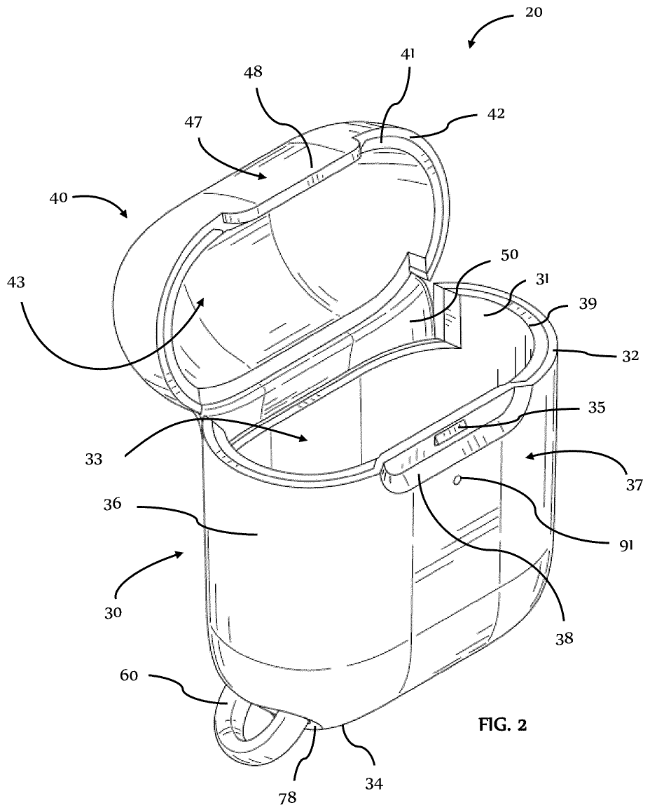

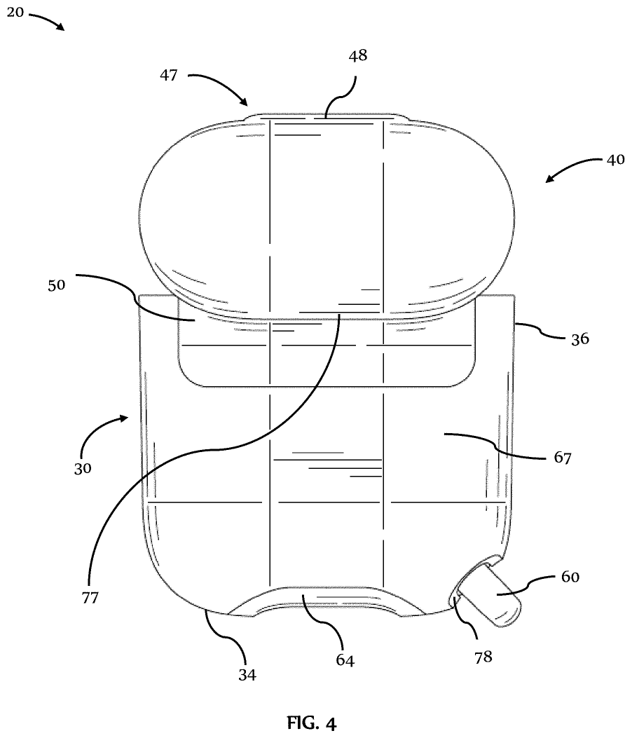

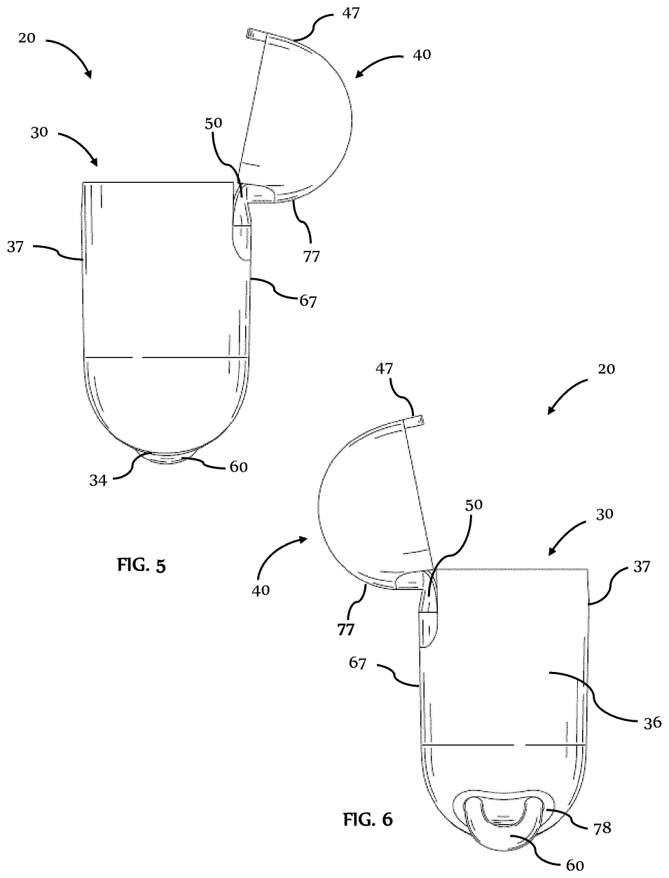

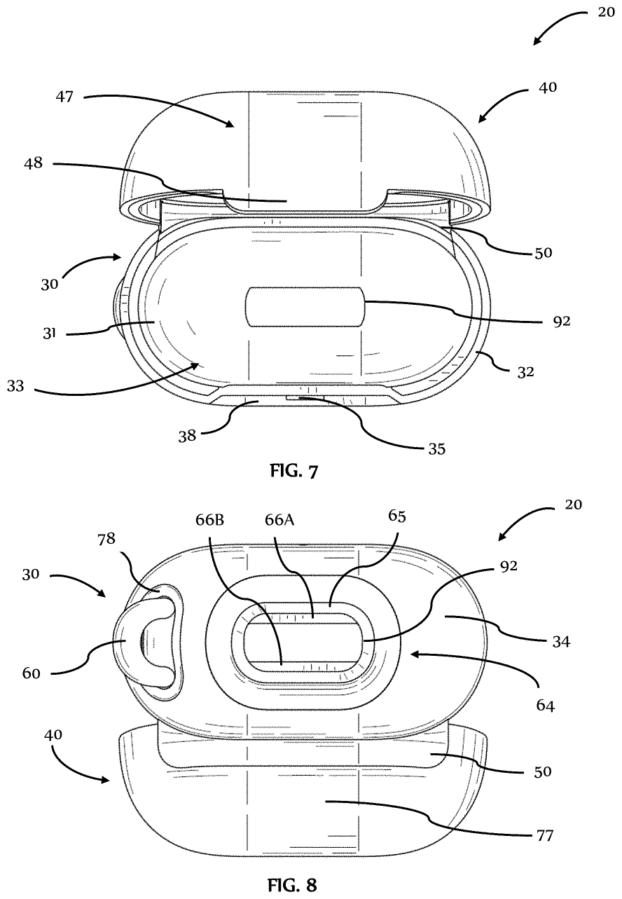

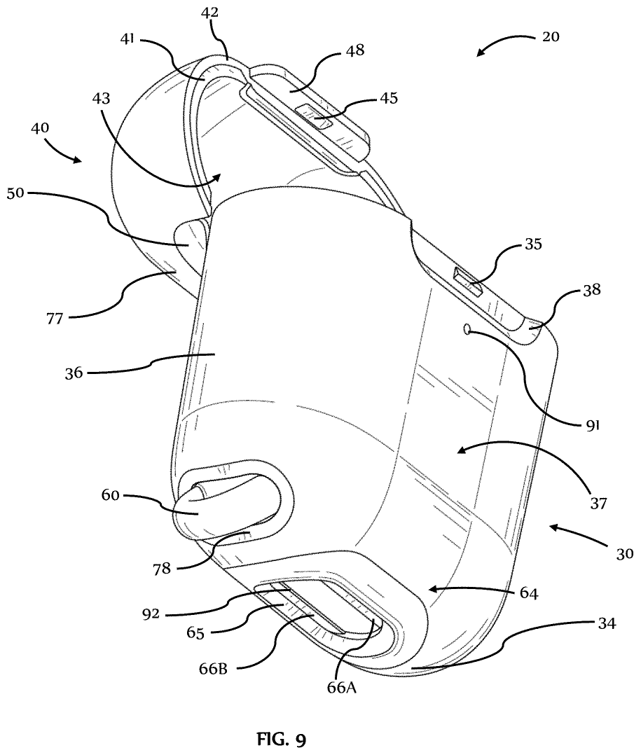

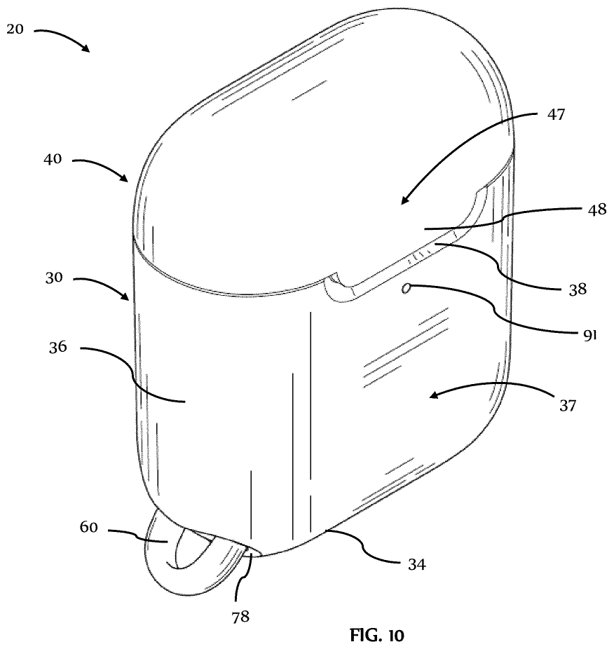

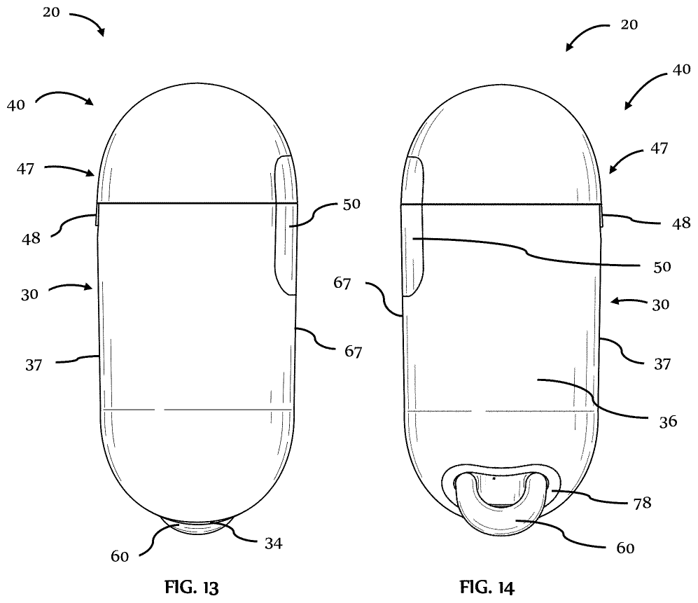

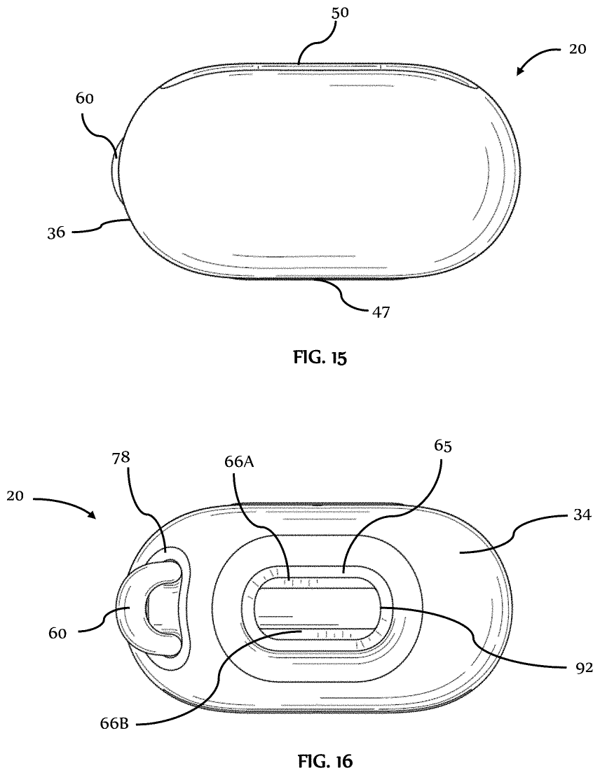

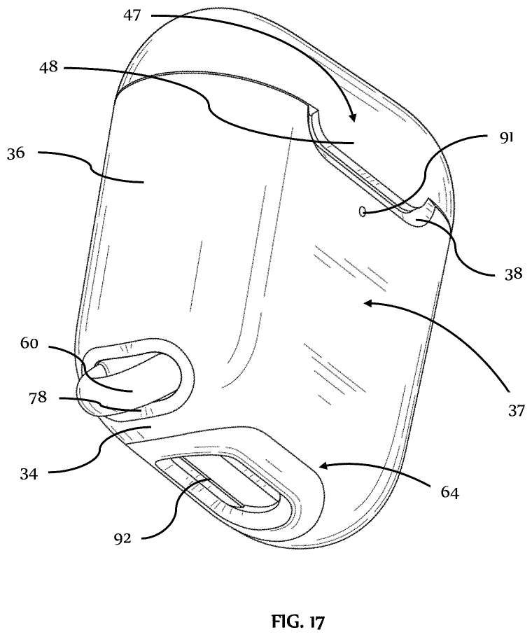

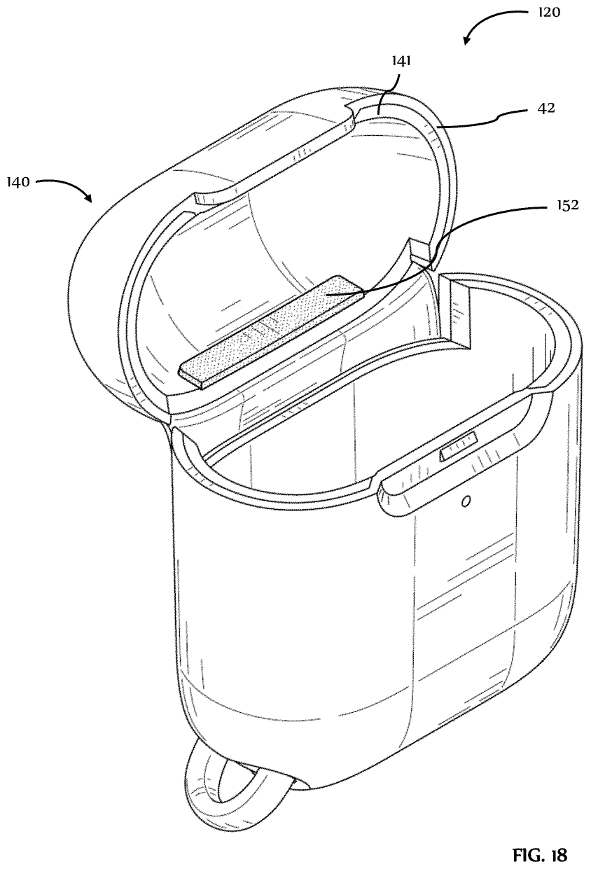

As shown, outer case 20 includes base portion 30 and lid portion 40 attached to and closeable onto the base portion via connecting portion 50. Base portion 30 covers an entirety of an external surface of charging base 12 and lid portion 40 covers an entirety of an external surface of charging lid 15 such that upon closure of the lid portion onto the base portion of outer case 20 with charging case 10 arranged within the base portion, the entirety of the charging case is enclosed by the outer case (see FIGS. 10 and 17). During use of outer case 20 in either an open position as shown in FIGS. 2-9 or in a closed position as shown in FIGS. 10-17, only one or none of left and right earbuds 6, 7 may be suitably received in the respective left and right base cavities 13, 14 of charging base 12.

Referring now to FIGS. 2-9, base portion 30 of outer case 20 includes inner base layer 31 and outer base layer 32 attached to the inner base layer to form a base receptacle 33 defined by the inner base layer. As in the example shown, base receptacle 33 may conform or substantially conform to the shape of charging base 12 of charging case 10 such that the charging base is held in place by the base receptacle in any orientation of the charging base, including when outer case 20 is in the open position. Lid portion 40 of outer case 20 includes inner lid layer 41 and outer lid layer 42 attached to the inner lid layer to form a lid receptacle 43 defined by the inner lid layer. Lid receptacle 43 conforms or substantially conforms to the shape of charging lid 15 of charging case 10 such that the charging lid is held in place by the lid receptacle in any orientation of the charging lid, including when outer case 20 is in the open position. Either one or both of the combination of inner base layer 31 and outer base layer 32 and the combination of inner lid layer 41 and outer lid layer 42 may be co-molded/co-casted together or otherwise permanently affixed to each other, such as with an adhesive, in the manner further described in U.S. Pat. No. 8,755,852 and U.S. Patent Application Publication Nos. 2019/0075899 A1 and 2019/0075900 A1, the entireties of the disclosures of which are hereby incorporated by reference herein. Thicknesses of each of inner base layer 31, inner lid layer 41, outer base layer 32, and outer lid layer 42 may be in the range of 0.5 mm to 2.0 mm. Moreover, an overall thickness of each of the combination of inner base layer 31 and outer base layer 32 and the combination of inner lid layer 41 and outer lid layer 42 may be in the range of 1.0 mm to 5.0 mm. In some arrangements, either one or both of the combination of inner base layer 31 and outer base layer 32 may be a single base layer and the combination of inner lid layer 41 and outer lid layer 42 may be a single lid layer.

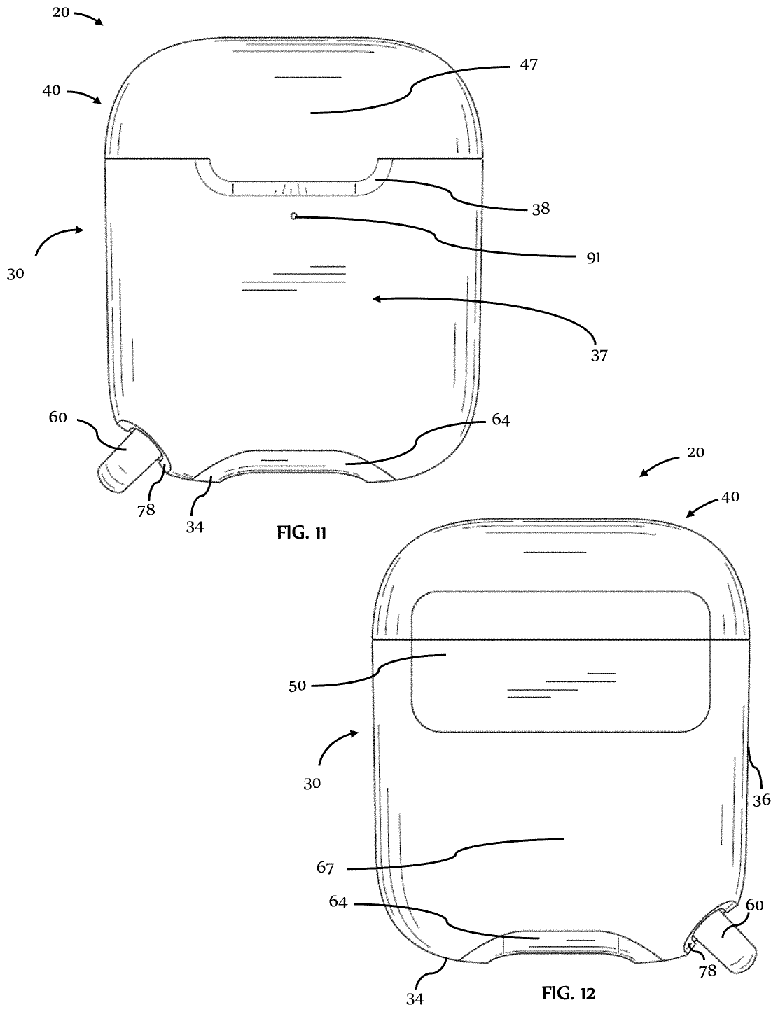

As shown for example in FIG. 2, connecting portion 50 acts as a flexible hinge. In this example, connecting portion 50 extends across and along rear wall 67 of base portion 30 and rear wall 77 of lid portion 40. In this example, connecting portion 50 is overmolded onto lid portion 40 and includes tabs (not shown) snapped into corresponding holes of outer base layer 32 to inhibit pull out of the connecting portion from the outer base layer and retain the connecting portion in the outer base layer. In alternative arrangements, the connecting portion may be overmolded onto base portion 30 and snapped into corresponding holes of outer lid layer 42. In other alternative arrangements, the connecting portions may be attached to the base portion and the lid portion in another manner, such as through the use of an adhesive or by way of other mechanical connections. When outer case 20 is in the closed position, connecting portion 50 is generally in the form of a curved sheet, as shown for example by FIGS. 12-14. In this manner, rear wall 67 of base portion 30, connecting portion 50, and rear wall 77 of lid portion 40 are flush when outer case 20 is in the closed position such that these portions do not catch on other objects during use of the outer case. When outer case 20 is in the open position, connecting portion 50 is generally in the form of a paraboloid, as shown for example by FIGS. 2, 5, and 6. In this manner, lid portion 40 attached to connecting portion 50 rotates upwardly and away from base portion 30 during opening of outer case 20.

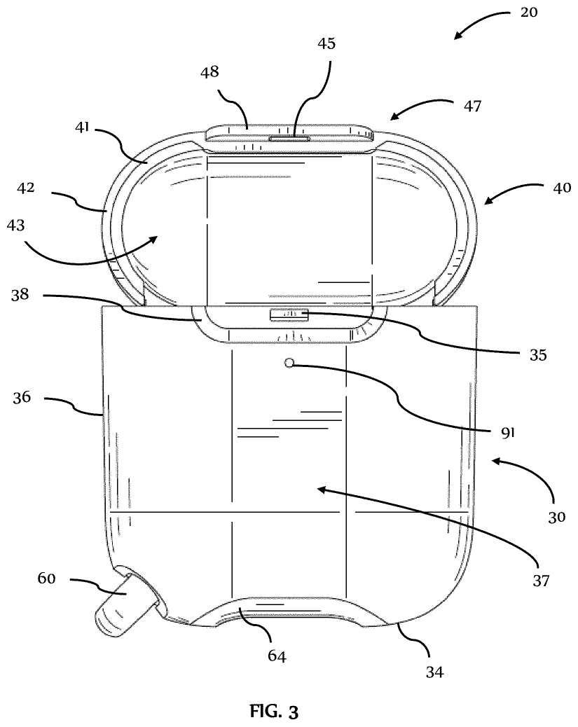

As shown, outer case 20 further includes attachment loop 60 extending from base portion 30. A separate hook, key ring, carabiner 18, and the like may be attached to attachment loop 60 for easier carrying of outer case 20 and its contents or attachment of outer case 20 and its contents to another object such as a bag or belt loop of a user. Attachment loop 60 extends from inner base layer 31 and through an opening defined by outer base layer 32. In some arrangements, attachment loop 60 is integral with inner base layer 31 such that the attachment loop and the inner base layer are inseparable without fracture. In other arrangements, attachment loop 60 may be attached to inner base layer 31 by an adhesive, by way of a tight interference fit within the inner base layer, by way of a flange extending from the attachment loop and preventing separation of the attachment loop from the inner base layer, or by other means known to those skilled in the art. As in the example shown, a corner formed by bottom wall 34 and side wall 36 of base portion 30 may be truncated such that a substantial portion of attachment loop 60 (see FIG. 3) extends at an oblique angle to the bottom wall and the sidewall of the base portion within the truncated region of the base portion. In this manner, attachment loop 60 is configured to minimize possible snags on or other interference with objects in the external environment. Attachment loop 60 extends from and, in the example shown, is integral with loop insert 78. Loop insert 78 includes tabs (not shown) snapped into corresponding holes of outer base layer 32 to inhibit pull out of the loop insert from the outer base layer and retain the loop insert in the outer base layer. In some alternative arrangements, attachment loop 60 may be in the form of a hook. In this manner, attachment loop 60 may be attached directly to a bag or belt loop or other object.

Front wall 37 of base portion 30 of outer case 20 includes base flange 35 set into and extending from base recess 38 of the base portion, and front wall 47 of lid portion 40 of the outer case includes lid flange 45 set into and extending from lid flap 48 of the lid portion. Lid flap 48 is located on lid portion 40 and base recess 38 is located on base portion 30 such that upon closure of outer case 20, the lid flap is received within the base recess as shown in FIGS. 10, 11, and 13-17. Lid flange 45 is aligned with base flange 35 such that upon closure of outer case 20, the lid flange overlaps and is below the base flange such that the base flange is closer to base opening 39 of base receptacle 33 than the lid flange. As in the example shown, either one or both of base flange 35 and lid flange 45 is configured with an undercut such that a tip of the other of the base flange and the lid flange is received within such undercut or undercuts when outer case 20 is in the closed position. The use of the undercuts inhibits relative slipping between the base and lid flanges 35, 45, allowing the closure of base portion 30 onto lid portion 40 to be more secure. In some alternative arrangements, one or more dual hinge latches as known to those skilled in the art may be utilized in place of or in combination with flanges like those of base and lid flanges 35, 45. Such dual hinge latches may be in the form of latches used on fishing tackle boxes sold commercially today.

As in the example shown in FIGS. 1-17, outer case 20 may define additional openings or cutouts at various locations so as to allow various buttons, ports, or features of a protected device, such as charging case 10, to be accessed without having to remove the protected device 10 from the outer case. For example, opening 91 through front wall 37 of outer case 20 is configured to expose a light indicator, e.g., a light-emitting diode (LED) indicator, of charging case 10 to allow a user to be alerted when charging of earbuds 6, 7 is complete or when additional charging is needed, depending on the default settings of the LED indicator. As another example, opening 92 extends through port insert 64 received in a hole defined by bottom wall 34 to provide access to a charging port of charging base 12. In this example, port insert 64 includes tabs (not shown) snapped into corresponding holes of outer base layer 32 to inhibit pull out of the port insert from the outer base layer and retain the port insert in the outer base layer. Port insert 64 includes port body 65 and port ribs 66A, 66B attached on opposite sides of a top portion of the port body. Port body 65 defines a lead-in chamfer and port ribs 66A, 66B in combination with the top portion of the port body define opening 92. The lead-in chamfer of port body 65 and port ribs 66A, 66B provide a guide for the insertion of a peripheral component, such as a connector of a power plug, through opening 92 in which the port ribs provide a slight resistance during the insertion of the peripheral component and thereby provide tactile feedback to a user that the connector is received in the opening.

Inner base layer 31, inner lid layer 41, and port insert 64 preferably may be made of elastomeric or other suitably flexible materials. Preferred materials include thermosetting plastics with a hard durometer having shore 30D to shore 100D, polycarbonate, poly(methyl methacrylate) (“PMMA”), metals, acrylonitrile butadiene styrene (“ABS”), PMMA, polyethylene terephthalate (“PET”), high durometer thermoplastic elastomers (“TPEs”) and thermoplastic polyurethanes (“TPUs”) having shore 30D to shore 100D, and any combination thereof. In some arrangements, either one or both of inner base layer 31 and inner lid layer 41 may be made of a non-Newtonian dilatant material, as further described in U.S. Patent Application Publication Nos. 2019/0075899 A1 and 2019/0075900 A1. Inner base layer 31 and inner lid layer 41 preferably are made of the same material, although these layers may be made of different materials.

Outer base layer 32 and outer lid layer 42 preferably may be made of a rigid or hard material to create a rigid/hard shell which provides at least some impact protection as well as protection from being punctured by impacts with sharp objects. Preferred hard/rigid materials include hardened plastic material, a rigid or semi-rigid plastic material, a rigid/hard rubber material, a polycarbonate material, a metal, an alloy, a para-aramid material, wood, glass, mirror, quartz, and any combination thereof, and may be any color or texture. Such materials may be the same as or may mimic the material or materials used for charging case 10. Outer base layer 32 and outer lid layer 42 preferably are made of the same material, although these layers may be made of different materials.

Any one or any combination of surfaces of inner base layer 31, outer base layer 32, inner lid layer 41, and outer lid layer 42 exposed to users in either one or both of the open and closed positions of outer case 20 may be treated with an antimicrobial material applied as a coating or any one of such layers 31, 32, 41, 42 may have an antimicrobial material embedded into such layers. Preferred antimicrobial materials include silver or silver alloy (e.g., silver sodium hydrogen zirconium phosphate), copper or copper alloy, organosilanes, quaternary ammonium compounds (e.g., dimethyloctadecyl (3-trimethoxysilyl propyl) ammonium chloride, alkyldimethylbenzylammonium chloride, and didecyldimethylammonium chloride), chlorhexidine, chlorhexidine incorporated hydroxyapatite materials, chlorhexidine-containing polymers (e.g., chlorhexidine-containing polylactide), and antibiotics (e.g., gentamicin, cephalothin, carbenicillin, amoxicillin, cefamandol, tobramycin, vancomycin). Preferred antimicrobial coatings include coatings containing any of the aforementioned antimicrobial materials, chlorhexidine-containing polylactide coatings on an anodized surface, and polymer and calcium phosphate coatings with chlorhexidine. These antimicrobial treatments aid in reducing the presence and preventing the growth of microbes (e.g., bacteria, fungi, viruses, etc.), thereby aiding in preventing the spread of related sicknesses, illnesses, or diseases.

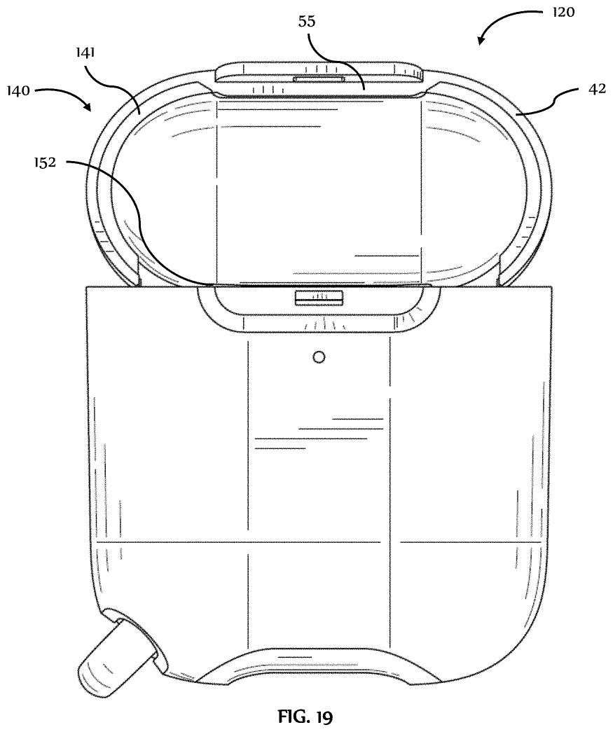

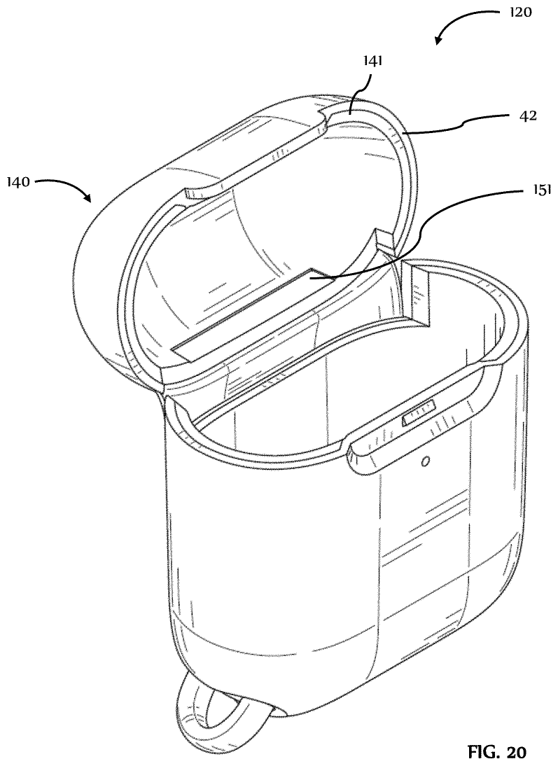

Referring now to FIGS. 18-20, in an alternative arrangement, outer case 120 is the same or substantially the same as outer case 20 with the exception that outer case 120 includes lid 140 in place of lid 40. Lid 140 is the same or substantially the same as lid 40 with the exception that lid 140 includes inner lid layer 141 defining recess 151 and further includes cushion 152 received in the recess. Cushion 152 extends beyond inner lid layer 141 and is oriented such that the cushion opposes ridge 55 of outer lid layer 42. In this manner, upon insertion of charging lid 15 of charging case 10 into outer case 120, cushion 152 and ridge 55 each contact the charging lid to aid in retaining the charging lid in place in the outer case. As in the example shown, cushion 152 may be made of silicone or other elastic material such that the cushion may be flexible to provide an interference fit with an inserted charging lid 15 and to provide a frictional surface to further aid in retaining the charging lid in outer case 120.

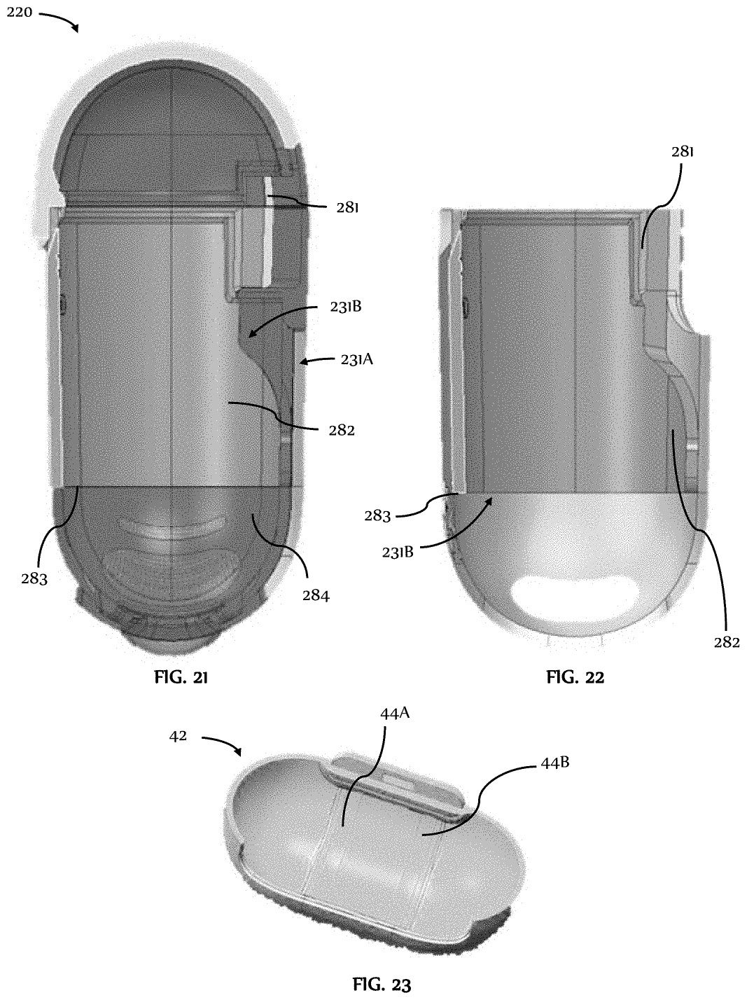

Referring now to FIGS. 21 and 22, in another alternative arrangement, outer case 220 is the same or substantially the same as outer case 20 with the exception that outer case 220 includes upper inner base layer 231A and lower inner base layer 231B in place of inner base layer 31. Lower inner base layer 231B is symmetrical about an axis extending from the top to the bottom of outer case 220 and further has a substantially hourglass shape defined by upper wings 281 (only one upper wing being shown as the other wing is symmetrical to the upper wing shown) and lower wings 282 (only one lower wing being shown as the other wing is symmetrical to the lower wing shown) and upper base layer 231A extends within the rest of outer case 220 such that, together, upper inner base layer 231A and lower inner base layer 231B take the same form as inner base layer 31 of outer case 20. A thickness of lower inner base layer 231B defines undercut 283 that extends over bottom portion 284 of upper inner base layer 231A to inhibit pull out of the upper inner base layer from outer case 220. A thickness of upper inner base layer 231A extends over lower wings 282 of lower inner base layer 231B to inhibit pull out of the lower inner base layer from outer case 220.

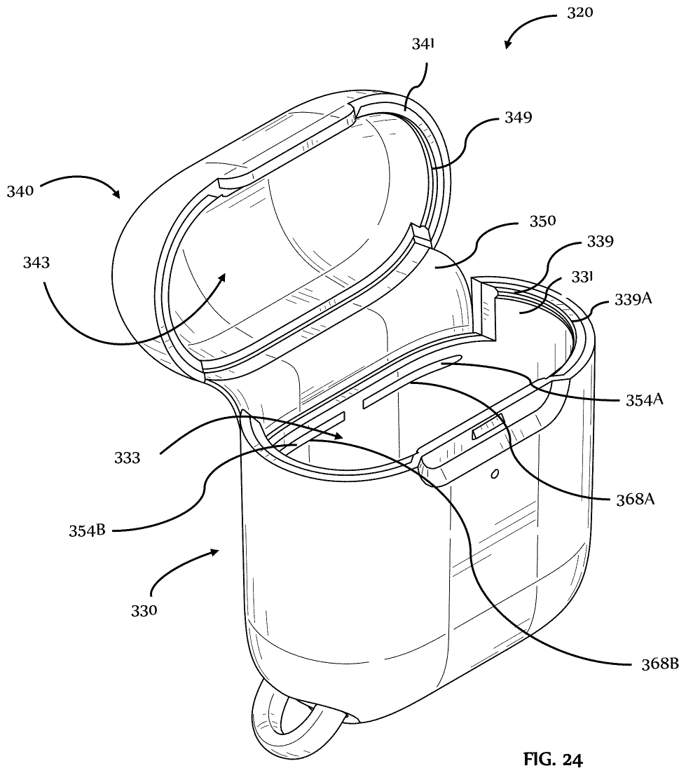

As shown in FIG. 23, an underside of outer lid layer 42 includes a pair of bumps 44A, 44B having central axes extending within parallel planes. Outer lid layer 42 is utilized for outer cases 20, 120, 220, and the like.

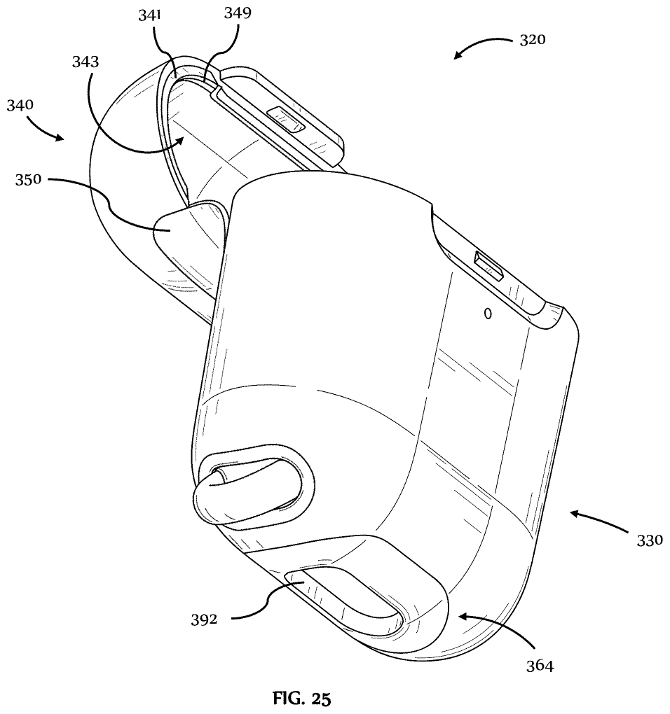

Referring now to FIGS. 24 and 25, in yet another alternative arrangement, outer case 320 is substantially the same as outer case 20 with the notable exceptions that outer case 320 generally includes base 330 in place of base 30, lid 340 in place of lid 40, and connecting portion 350 in place of connecting portion 50. Base 330 includes inner base layer 331 having base ribs 339 that define opening 339A along a top portion of the inner base layer in place of inner base layer 31 that excludes such base ribs. Base ribs 339 provide additional friction against charging base 12, relative to surfaces without such ribs, when the charging base is inserted into base receptacle 333 defined by inner base layer 331. Base 330 further includes port insert 364 which is substantially the same as port insert 64 with the notable exception that port insert 364 excludes port ribs 66A, 66B such that opening 392 defined by the port insert provides less resistance to any connector of a power cord or other peripheral device inserted into the opening. Connecting portion 350 of outer case 320 includes tabs 354A, 354B that, unlike the corresponding tabs of connecting portion 50 of outer case 20, extend into corresponding holes 368A, 368B of inner base layer 331. In this manner, unlike inner base layer 31 of outer case 20, inner base layer 331 does not press against tabs 354A, 354B.

Lid 340 includes inner lid layer 341 having lid ribs 349 along a bottom portion of the inner lid layer in place of inner lid layer 41 that excludes such lid ribs. Lid ribs 349 provide additional friction against charging lid 15, relative to surfaces without such ribs, when the charging lid is inserted into lid receptacle 343 defined by inner lid layer 341.

It should be understood that covers for other audio device systems, such as but not limited to microphones, voice recorders, and the like, that may or may not be encased in or accompanied by a charging case or charging dock, as well as other handheld electronic device systems, such as but not limited to remote controllers, pagers, video game wands or other controllers, and the like, that may or may not be encased in or accompanied by a charging case or charging dock, are encompassed by the present invention.

It is noted that the terminology used above is for the purpose of reference only, and is not intended to be limiting. For example, terms such as “upper,” “lower,” “above,” “below,” “rightward,” “leftward,” “clockwise,” and “counterclockwise” refer to directions in the drawings to which reference is made. As another example, terms such as “inward” and “outward” may refer to directions toward and away from, respectively, the geometric center of the component described. As a further example, terms such as “front,” “rear,” “side,” “left side,” “right side,” “top,” “bottom,” “horizontal,” and “vertical” describe the orientation of portions of the component within a consistent but arbitrary frame of reference which is made clear by reference to the text and the associated drawings describing the component under discussion. Such terminology will include the words specifically mentioned above, derivatives thereof, and words of similar import.

While this invention has been described in conjunction with the specific embodiments outlined above, it is evident that many alternatives, modifications, and variations will be apparent to those skilled in the art. Indeed, the disclosure set forth herein includes all possible combinations of the particular features set forth above, whether specifically disclosed herein or not. For example, where a particular feature is disclosed in the context of a particular aspect, arrangement, configuration, or embodiment, that feature can also be used, to the extent possible, in combination with and/or in the context of other particular aspects, arrangements, configurations, and embodiments of the invention, and in the invention generally. Moreover, the disclosure set forth herein includes the mirror image, i.e., mirror configuration, taken from any perspective of any drawing or other configuration shown or described herein. Accordingly, the preferred embodiments of the invention as set forth above are intended to be illustrative, not limiting. Various changes may be made without departing from the spirit and scope of the inventions as defined in the following claims.

In addition, it is noted that citation or identification of any document in this application is not an admission that such document is available as prior art to the present invention.

1. An outer case for covering a handheld electronic device or handheld electronic device case, the case comprising:
a base including a first base layer made of an elastomeric first material and a second base layer attached to the first base layer and made of a second material different from the first material;
a lid including a first lid layer made of an elastomeric third material and a second lid layer attached to the first lid layer and made of a fourth material different from the third material; and
a connecting portion attached along a rear wall of the base and a rear wall of the lid, wherein the rear wall of the base, the rear wall of the lid, and the connecting portion are flush when the outer case is in a closed state with the lid covering an opening defined by the base, and wherein the connecting portion suspends the lid when the outer case is in a fully open state with the lid spaced from the base.

2. The outer case of claim 1, wherein the second and the fourth materials are rigid materials.

3. The outer case of claim 1, wherein the first base layer and the first lid layer define an interior of the outer case and the second base layer and the second lid layer define an exterior of the outer case.

4. The outer case of claim 1, wherein the first material and the third material are the same material and the second material and the fourth material are the same material.

5. The outer case of claim 1, wherein the connecting portion is a hinge such that the lid rotates relative to the base via the connecting portion in a direction away from the base towards the fully the open state of the outer case.

6. The outer case of claim 1, wherein the lid includes a lid flange and the base includes a base flange closer to an opening defined by the base in an open state of the outer case than the lid flange when the outer case is in the closed state.

7. The outer case of claim 1, further comprising a hook or loop extending from the base and integral with the first base layer such that the one of the hook or the loop and the first base layer are inseparable without fracture of either one or both of the one of the hook or the loop and the first base layer.

8. The outer case of claim 7, wherein the one of the hook or the loop extends from the first base layer through the second base layer.

9. The outer case of claim 1, wherein the base, the lid, and the connecting portion are integral such that the base, the lid, and the connecting portion are inseparable without fracture of any one or any combination of the base, the lid, and the connection portion.

10. The outer case of claim 1, wherein either one or both of the base and the lid are made of co-molded or co-casted polymer layers.

11. The outer case of claim 1, wherein either one or both of the base and the lid are made of a plurality of layers attached by an adhesive.

12. The outer case of claim 1, wherein the first material and the third material each comprise at least one material selected from the group consisting of thermoplastic elastomers (“TPEs”), thermoplastic polyurethane (“TPU”), silicone, rubber, and any combinations thereof.

13. The outer case of claim 1, wherein the second material and the fourth material each comprise at least one material selected from the group consisting of hardened plastic materials, rigid or semi-rigid plastic materials, rigid rubber materials, polycarbonate materials, metals, alloys, para-aramid materials, wood, glass, mirror, quartz, and any combinations thereof.

14. The outer case of any one claim 1, wherein an outer surface or outer surfaces of any one or any combination of the first base layer, the second base layer, the first lid layer, and the second lid layer include an antimicrobial substance or treatment.

15. The outer case of claim 14, wherein the antimicrobial substance or treatment is selected from the group consisting of silver and silver alloys, copper and copper alloys, organosilanes, quaternary ammonium compounds, chlorhexidine, chlorhexidine incorporated hydroxyapatite materials, chlorhexidine-containing polymers, and antibiotics.

16. The outer case of claim 1, wherein the outer case conforms to and is configured for covering a case for storing earbuds.

17. The outer case of claim 1, wherein the outer case is configured for covering one or more earbuds, a microphone or case therefor, a voice recorder or case therefor, a remote control device or case therefor, a pager or case therefor, or a video game controller or case therefor.

18. The outer case of claim 1, further comprising:
a cushion attached to the lid; and
a ridge attached to the lid on a side of the lid opposite the cushion, the cushion being configured to compress the one of the handheld electronic device or handheld electronic device case covered by the outer case.

19. A handheld electronic device system comprising:
either one or both of a handheld electronic device and a handheld electronic device case configured for holding the electronic device; and
the outer case of claim 1 enclosing the one or both of the electronic device and the electronic device case in a first state and exposing the one or both of the electronic device and the electronic device case in a second state.

20. An outer case for covering a handheld electronic device or handheld electronic device case, the case comprising:
a base;
a lid configured for placement onto the base, the lid having a first state in which the lid is placed on the base and a second state in which the lid is spaced from the base; and
a flexible hinge attached to the base and the lid, wherein the flexible hinge is in the form of a curved sheet when the lid is in the first state and is in the form of a paraboloid when the lid is in the second state.
